(19) United States
(12) Patent Application Publication
(10) Pub. No.: US 2009/0090313 A1
(43) Pub. Date: Apr. 9, 2009

(54) METHOD AND APPARATUS FOR ENHANCING THE UTILIZATION OF FUEL IN AN INTERNAL COMBUSTION ENGINE

(76) Inventor: Zachary A. Henry, SR., Corryton, TN (US)

Correspondence Address: PITTS AND BRITTIAN P C, P O BOX 51295, KNOXVILLE, TN, 37950-1295, US

(21) Appl. No.: 12/245,143

(22) Filed: Oct. 3, 2008

Related U.S. Application Data
(63) Continuation-in-part of application No. 12/203,621, filed on Sep. 3, 2008.
(60) Provisional application No. 60/977,954, filed on Oct. 5, 2007.

(51) Int. Cl. F02B 43/08

(52) U.S. Cl. 123/3; 123/536

(57) ABSTRACT

In one aspect of the present invention, a mixture of conventional gasoline and hydrogen-containing additive, such as ethanol, destined for use as a fuel for an ICE, is processed through a fuel generator interposed between a source of the fuel mixture and an internal combustion engine (ICE). Within the fuel generator, the mixture is subjected to electrolysis and then fed to the ICE, one objective being to more efficiently power the ICE, with a fuel mixture having a minimum, and preferably no gasoline in the mixture. A method and apparatus is disclosed.

### CROSS-REFERENCE TO RELATED APPLICATIONS

This application is a continuation in part of copending U.S. patent application Ser. No. 12/203,621, filed Sep. 3, 2008, entitled: METHOD AND APPARATUS FOR CONTROLLING AN ELECTRIC MOTOR, and is a non-provisional application based upon provisional U.S. Patent Application, Ser. No. 60/977,954, filed Oct. 5, 2007, entitled FUEL GENERATOR, the entirety of each such application being incorporated herein by reference and priority is claimed based on such applications.

### FIELD OF INVENTION

This invention relates to methods and apparatus for generation and delivery of fuel to an internal combustion engine (ICE)

### BACKGROUND OF THE INVENTION

Control of the operation of internal combustion engines is conventionally achieved employing control over the quantity of a stream of combustible gas(es) introduced to the engine by means of a carburetor, for example. Fuel injection also has been employed in a similar manner. In each instance, the concept involves feeding of a suitable mixture of air and a combustible gas such as petroleum-based products (gasoline, diesel fuel, etc.) and fuels labeled as biomass fuels, hydrogen and the like. Alternatively, the prior art has also included the concept of employing electric motors in addition to, or in lieu of ICEs. In the art, alternative fuel(s) are actively being sought which can reduce the adverse effects on the environment attributable to their use and/or which are less expensive than currently available fuels and/or whose sources are abundantly available and, preferably, renewable. Combinations of these fuels and other motor vehicle powering concepts have had only limited success for various reasons such as cost, effectiveness, availability, storage, delivery to consumers, etc.

One particular fuel proposed for powering ICEs is ethanol. In current practice, ethanol is mixed with gasoline, for example, in an effort to reduce the quantity of gasoline consumed by ICEs. About ten per cent ethanol mixed with conventional gasoline has been proposed and is in use in certain localities.

It is generally noted that with the dilution of conventional gasoline with ethanol, because ethanol has less relative energy, the efficiency of engine performance may be reduced as compared to the use of only gasoline as the engine fuel.

In the present disclosure the term “petrol” is at times employed to include gasoline, diesel or other petroleum based fuel for ICEs.

### SUMMARY OF THE INVENTION

In accordance with one aspect of the present invention, a mixture of conventional gasoline and a hydrogen-containing additive, such as ethanol, destined for use as a fuel for an ICE, is processed through a fuel generator interposed between a source of the fuel mixture and the ICE. Within the fuel generator, the mixture is subjected to electrolysis and then fed to the ICE, one objective being to more efficiently power the ICE, with a fuel mixture having a minimum, and preferably no, gasoline in the mixture.

### BRIEF DESCRIPTION OF THE DRAWINGS

FIG. 1 is a schematic diagram depicting one embodiment of a system embodying various aspects of the present invention;

FIG. 2 is a diagrammatic sectional side view of one embodiment of an apparatus embodying various aspects of the present invention;

FIG. 3 is a diagrammatic sectional side view of a further embodiment of an apparatus embodying various aspects of the present invention;

FIG. 4 is a diagrammatic side view of a still further embodiment of apparatus embodying various aspects of the present invention; and

FIG. 5 is a diagrammatic side view of the embodiment depicted in FIG. 4 and showing directional fluid flow into, through, and exiting the apparatus.

### DETAILED DESCRIPTION OF THE INVENTION

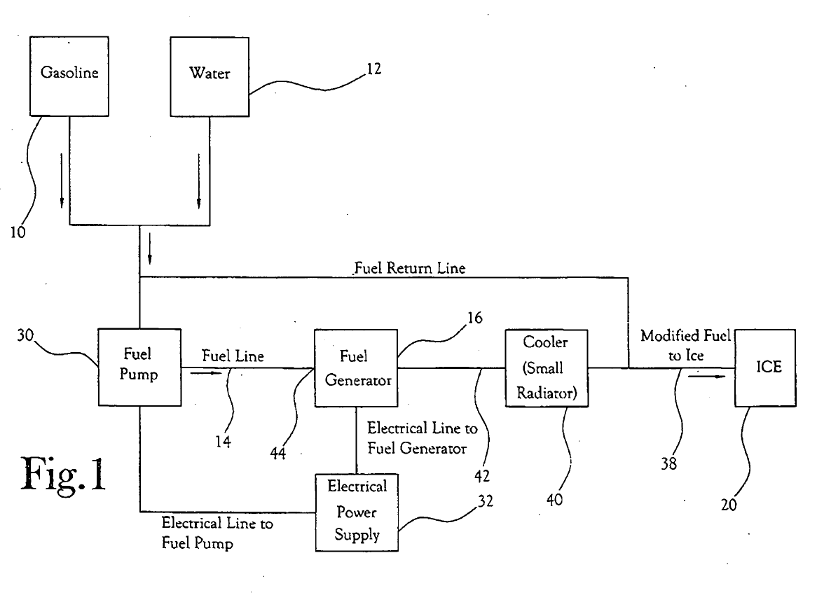

Referring to the several Figures, in FIG. 1 there is depicted one embodiment of a system of the present invention for processing a mixture of gasoline and ethanol for example, through electrolysis and fed to the existing fuel system of the ICE. As noted, the mixture employed may be one of the gasoline/ethanol mixtures (petrol) currently commercially available “at the pumps where ICE fuel is offered for sale. One such mixture commonly is designated at the pumps as “E10 for 10% ethanol”.

In the embodiment of the system of FIG. 1, a quantity of the petrol is stored in a first tank 10 and a quantity of water and/or electrolysis enhancer is stored in a second tank 12. The individually controlled discharges from the two tanks are fed into a common conduit 14 after moving through the fuel pump 30 and before flowing into the fuel generator 16 of the present invention.

Within the fuel generator, the mixture is subjected to electrolysis and the output from the fuel generator is fed through a conduit 18 to a carburetor or fuel injection system of the ICE 20.

Power for operation of a fuel pump 30 and the fuel generator may be provided as by a conventional electrical power supply 32 (e.g. such as the common 12 volt DC automobile battery). In one embodiment, the DC output from the battery may be fed through an electrical inverter (not shown) to convert the DC current to AC current. In any event, the battery power is electrically connected to the fuel pump and the fuel generator. As appropriate, conventional electrical controls and special systems for regulation and modification of the power supplied may be employed to each of the fuel pump and the fuel generator. In the depicted embodiment, a cooler 40 (e.g., relatively small radiator) may be interposed for some applications that generate excessive heat along the length of the conduit 42 leading from the fuel generator to the carburetor/injection system for the ICE.

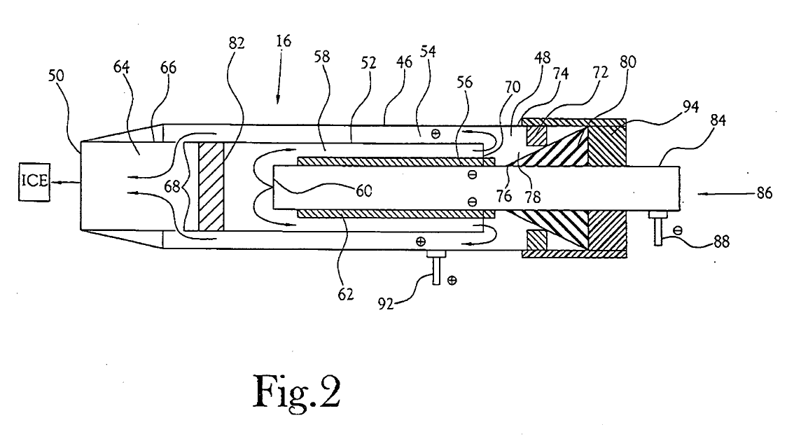

The schematically depicted fuel generator of FIG. 2 includes an elongated cylindrical outer housing 46 (e.g., an electrically conductive metal pipe) having entrance and exit opposite ends 48 and 50 respectively. Concentrically within the outer housing there is provided an elongated cylindrical intermediate housing 52 (e.g., an electrically conductive metal pipe) which extends between the exit end 50 of the outer housing and a location proximate, but spaced apart from the entrance end 48 of the outer housing, thereby defining therebetween a first elongated annular fluid flow chamber 54. Further, concentrically within the intermediate housing, there is provided an inner housing 56, (e.g., an electrically conductive metal pipe), having a diameter which is less than the diameter of the intermediate housing, so that there is defined a second elongated annular chamber 58 between the intermediate housing and the inner housing for fluid flow therethrough. The exit end of the intermediate housing is electrically joined to the exit end 50 of the positively charged outer housing thereby providing a positive electrical charge to the intermediate housing. The inner housing includes an exit end 60 which terminates proximate to, but spaced apart from a disc seal 82 which closes the intermediate housing 52 at a location between the exit end 60 of the inner housing and the exit end 50 of the outer housing. Within the space 64 between this disc seal and the exit end of the outer housing, the wall of the intermediate housing is perforated 68 for fluid flow from the first annular chamber 54 between the intermediate housing and the outer housing, thence out of the fuel generator through the exit end 50 of the outer housing.

The entrance end 48 of the outer housing outboard of the entrance end 70 of the intermediate housing is sealed fluid tight. In the depicted embodiment, this closure of the outer housing is partially accomplished by welding, or similarly joining, the outer circumference of a washer 72 to the inner wall 74 of the outer housing at a location slightly inboard of the entrance end 48 of the outer housing. This washer firstly functions to partially close the entrance end of the outer housing so that fluid flow from the second annular chamber 58 is diverted into the first annular chamber 54 defined between the outer housing and the intermediate housing. Secondly, this washer encircles the outer wall 76 of the inner housing but leaves a space between the washer and the outer wall 76 of the inner housing. Further sealing of the space between the washer and the outer wall of the inner housing is by means of a compressible, electrically non-conductive conical bushing 80 which is captured between the washer and a pressure ring 82 which may be threaded onto the outer wall of the first housing and which is adapted to bear against the bushing to effect fluid flow sealing of the space between the washer and the outer wall of the inner housing. As depicted in FIG. 2, the entrance end 84 of the inner housing projects outboard of the fuel generator to define an outboard infeed 86 to the fuel generator, along with a first electrode 88. Electrical connection of the outer housing may be through an electrode 92.

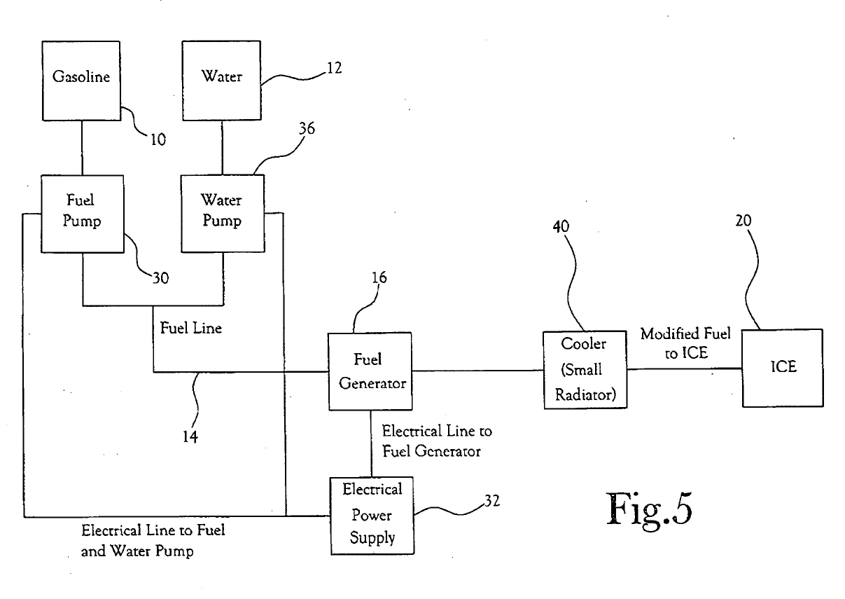

The petrol and the water/enhancer must be forced into the fuel line 14 and through the fuel generator as shown in FIG. 1 with appropriate pumps or other energy source. Commonly, a fuel pump 30 for the petrol is installed by the vehicle manufacturer. In the embodiment of the present invention depicted in FIG. 5, a further pump or other method, may be provided to force the water into the fuel line immediately prior to introduction of the petrol and water into the fuel generator.

Thus, in the system depicted in FIG. 2, the fluid flows into and through the inner housing, thence into and through the chamber 58 defined between the negatively charged inner housing and the intermediate housing. When the fluid reaches the exit end of the inner housing, it reverses direction and moves through the annular chamber defined between the negatively charged inner housing and the positively charged intermediate housing where it is subjected to electrolysis by reason of the electrical charge imposed on the inner and intermediate housings. The fluid exits this chamber 58 at the entrance end 48 of the outer housing and is then redirected into and through the annular chamber 54 defined between the intermediate and the outer housings, the outer housing being charged positively. Following this passage along the length of the fuel generator through the chamber 54, the fluid exits by way of an exit end 50 of the outer housing.

As desired, the fuel generator may be provided with a return flow conduit leading from the exit conduit from the outer housing to the conduit through which the initial mixture of petrol and water/enhancer is fed to the fuel generator. The necessity for, and the position of the return flow conduit is dependent upon the characteristics of the individual fuel flow/carburetion system.

The circumferential junction between the outer housing and the projecting entrance end of the inner housing is sealed as by an electrically insulative pipe fitting 94 that is threaded to the outer housing 46. A hole exists in the pipe fitting 94 through which the inner housing extends. When the threaded, insulative fitting is screwed onto the outer housing, pressure is exerted on the compressible, electrically non-conductive bushing. Pressure is on both the washer 80 and the inner housing 56 to provide a fluid seal. By these means, the inner housing is fully electrically insulated from the outer housing. In this embodiment a degree of control of the electrolysis can be obtained by adjustment of the distance the infeed element is allowed to protrude into the generator. This can be accomplished in the following way. When the pipe fitting 82 is tightened, the flexible ring is pressed inward and sealed. When the fitting is loosened, the pressure is removed from the seal and the position of the inner housing can be adjusted. The seal can then be made again by tightening the non-conductive pipe fitting 82.

As depicted in FIG. 1, electrical power for electrolysis can be either direct or alternating current. The system used in the test discussed employed the 12 volt battery required for the automobile and attached a 12 volt de to 115 volt ac inverter as will be recognized by those skilled in the art. In the depicted embodiment, the 115 volt output of the inverter is used to power the electrolysis of the fuel generator.

The structure of the fuel generator for moving the fluid fuel mixture through an electrolysis field, can take many forms. The elongated concentric pipe construction depicted in (1) provides the advantages of an economical and easy method of construction with commonly available materials; (2) easy adaptation of fittings to tie into the ICE fuel line; (3) allowance for maximizing the total distance of fluid flow between the charged plates with minimum space requirement and maximum electrolysis effect; (4) the shape and size makes it easy to fit into available spaces; (5) adaptability to any internal combustion engine without substantial modification of the existing fuel system; (6) ease of installation with a minimum of auxiliary components; (7) no danger of explosion and no apparent effect on an existing CPU or other like controls for the ICE.

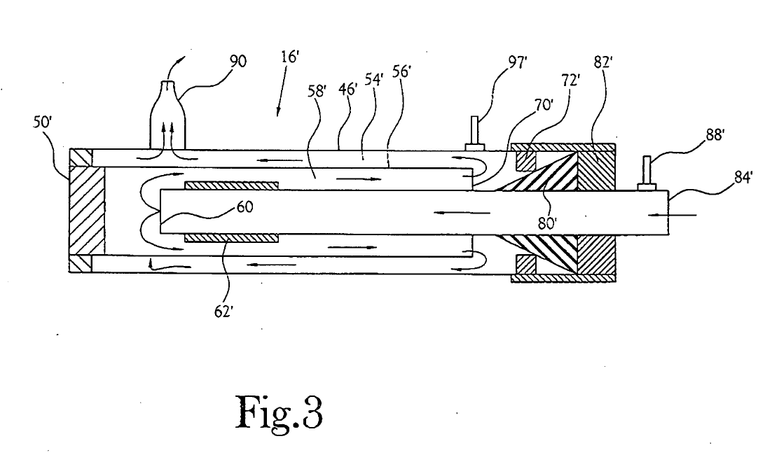

It will be recognized that the embodiment of the present invention depicted in FIGS. 1 and 2 defines a type of electrolysis chamber wherein the inner housing functions as a first electrode and the outer housing functions as a second electrode. The intermediate housing is function to separate the annular space between the inner housing and the outer housing into the first and second annular chambers, thereby increasing the residence time of the flowing fuel mixture within the electrolysis within the fuel generator. The incoming fuel mixture serves as an electrolyte and the fuel generator becomes an electrolysis unit that may be interposed between a source of a fuel mixture (electrolyte) and the hydrogen-enriched output from the fuel generator to the carburetor/fuel injection system of an ICE. In FIG. 3 there is depicted an embodiment of the present invention which is substantially the same as the embodiment depicted in FIG. 2 except the embodiment of FIG. 3 employs an exit port 90 located on the side of the outer housing in lieu of having the fuel mixture exit the fuel generator through an open end of the outer housing. Aside from the exit port aspect, the functioning of the system depicted in FIG. 3 is identical to the functioning of the system depicted in FIG. 2. Therefore, substantially all of the elements of the fuel generator system of FIG. 3 are identified with primed numerals taken from FIG. 2.

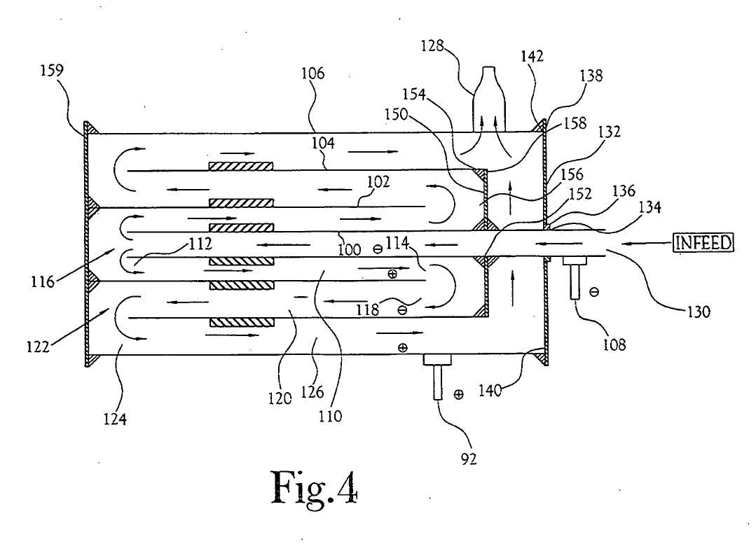

FIG. 4 depicts a further embodiment of the present invention. In this further embodiment, inner 100, first intermediate 102, second intermediate 104 and outer 106 cylindrical electrically-conductive housings (e.g., metal pipes) are mounted concentrically with one another to define the fuel generator. The inner housing is central of the fuel generator and serves as the infeed route for the introduction of a fuel mixture into the fuel generator (see arrows in FIG. 4). This inner housing is electrically negatively charged as by electrical current supplied through an electrode 108 affixed to the inner housing.

The inner housing, in combination with the first intermediate housing defines a first annular fluid flow chamber 110 between these housings, such chamber having an entrance end 112 and an exit end 114. As seen in FIG. 4, fuel mixture flowing into and through the inner housing is redirected from the exit end 116 of the inner housing into the entrance end of the first chamber thence along the first chamber to the exit end of the first chamber where the fluid flow is redirected laterally of the fuel generator and into the entrance end 118 of a second annular fluid flow chamber 120 defined between the first intermediate housing and the second intermediate housing. At the exit end 122 of the second annular chamber, the fluid flow is redirected laterally and into the entrance end 124 of a third annular fluid flow chamber 126 defined between the second intermediate housing and the outer housing. After passing through the multiple chambers, the fuel mixture exits the fuel generator through an exit port 128.

Notably, the entrance end 130 of the inner housing passes through and is electrically insulated from the first conductive plate 132 which is oriented perpendicularly of the inner housing. The juncture 134 of the metal plate and the inner housing is sealed with an electrically insulative pressure seal 136 to preclude the escape of fuel mixture out of the fuel generator at such juncture and to electrically isolate the plate from the inner housing. The outer circumference 138 of the first plate receives and is fixedly secured to the rim 142 of a first end 140 of the outer housing, thereby providing for mounting of such first end of the outer housing within the fuel generator. This joinder of the plate and the rim of the outer housing may be effected by welding techniques.

Further, internally of the fuel generator, there is provided a second metal plate 150 which is mounted in a perpendicular attitude with respect to the inner housing, the inner housing passing through the center of the second plate. At the juncture 152 of the second plate and the inner housing, the plate is in electrical engagement with the inner housing so that this plate is electrically charged with the same polarity as the inner housing. The rim 154 of the first end 156 of the first intermediate housing is joined to the outer circumference 158 of the second plate both for physical support of the second intermediate housing within the fuel generator and for providing for electrical connection of the plate and the second intermediate housing so that the second intermediate housing is of the same electrical polarity (negative) as the inner housing.

As noted, internally of the fuel generator, the second intermediate housing interposed between the inner housing and the first intermediate housing defines the third elongated annular fluid flow chamber 110 therebetween. In the depicted embodiment of FIG. 4, the non-entrance ends of the outer housing and the second intermediate housing are fixedly mounted within the fuel generator as by means of a third plate 159 which is oriented perpendicularly of the length of these housings. Specifically, the respective rims of the non-entrance end of each of the outer and second intermediate housings are welded to the third plate, thereby sealing these ends of these housings closed and providing support of these housings within the fuel generator. The third plate is electrically conductive, thereby permitting a positive charge to be applied to each of the outer housing and the second intermediate housing. Thus, when the several housings are assembled in their concentric array relative to one another, fuel mixture flowing into and through the fuel generator is exposed to three separate serially fluid-flow-connected chambers, each of which constitutes an electrolysis chamber. As seen in FIG. 4, after passing through these three chambers, the fuel mixture exits the fuel generator through an exit port 128 and fed to the carburetor/fuel injection system of an ICE. It is noted that the embodiment depicted in FIG. 4 may be expanded by providing additional cylindrical housings and defined chambers as required for modified fuel mixtures.

In each of the embodiments of the present invention as depicted in FIGS. 2 and 4, it has been found that subjecting the fuel mixture of electrolytic treatment within the fuel generator increases the efficiency of utilization of the common gasoline/ethanol fuel available in the marketplace. Further, it has been found that through the addition of a hydrogen-containing liquid to the petrol and passing a mixture of petrol and hydrogen-containing liquid through an electrolysis treatment will significantly enhance the efficiency of the utilization of the petrol in an ICE. In the present invention, it has further been found that the fuel generator may be relatively small in physical size. For example the fuel generator may be about 24 inches in length and between about 2 and 6 inches in diameter, making the invention readily applicable to existing motor vehicles without major installation effort.

The depicted fuel generator of FIG. 4 is constructed to provide multiple electrified surfaces for enhanced electrolysis. This electrolysis may be affected by (1) the number of pairs of oppositely charged surfaces: (2) the distance between the oppositely charged surfaces: (3) the overall length of the generator: (4) the degree of insertion of the infeed element into a given length outer element and (5) the electrical power supplied to power the electrolysis, and similar considerations, again all of which will be evident to one skilled in the art, given the present invention

In the system of the present invention, each of the electrolysis chambers is fabricated from cylindrical housings so arranged that the positive and negative housings fit concentrically within each other and are insulated from each other by electrically non-conducting bands placed around the cylindrical housings. The bands have a thickness that is very slightly less than the distance between the cylindrical electrode elements, thus, preventing the positive and negative elements from making electrical contact while permitting the fluid fuel mixture to flow freely through the annular spaces between the concentric cylindrical electrically charged housings. The direction of electrical current flow is not significant but, in the embodiments depicted in FIGS. 2-4, the inner housing is negatively charged and the other housings are positively electrically charged as depicted in the Figures.

In accordance with one aspect of the present invention, one useful fuel mixture for feeding into the fuel generator may comprise a mixture of gasoline (petrol) and an electrolysis enhancer e.g., a hydrogen-containing fluid, including ethanol and/or water. In the present invention, the water may be ordinary tap water, the electrolysis enhancer may be one ore more of a large variety of hydrogen-based fluids such as ethanol, glycerin, and the like, which, along with other material, will enhance the electrolysis process and promote the emulsion of the mixture for the generation of hydrogen and other gases to increase the fuel efficiency.

The present inventors have found that by subjecting the petrol/water and enhancer mixture to electrolysis, the mixture is enriched with products resulting from the electrolysis which, in combination with the petrol, may be employed as the sole fuel for powering an ICE. Mixtures comprising about 50% petrol and about 50% water and catalyst have been found effective in reducing the quantity of petrol consumed by an ICE by as much as 50% or more.

In tests of the present invention, a fuel generator system of the present invention was installed in a 1995 Chevrolet Tahoe with a 5.7 liter ICE that, without a fuel generator, consistently gets 10 miles to the gallon of petrol in town and 12 miles to the gallon of petrol on the road. With fuel generator of the embodiment depicted in FIG. 2 installed on this vehicle, and employing approximately 1 50-50% mixture of petrol and water/enhancer, this same ICE obtained 21 miles per gallon on the road.

Several factors that affect the electrolysis process include, but are not limited to, water/enhancer ratio, ratio of the amount of water/enhancer to the amount of petrol, electric field (spacing of the plates (elements) and voltage across the plates) and amount of time the electrolyte (fluid) spends between the plates (rate of flow and length of the plates). There is an interaction among the factors that affect the electrolysis so that the change of one factor may cause the affect of another factor (or all of the other factors) to change. The space between the plates and the length of the plates is fixed by the construction of the fuel generator. The water/enhancer ratio may be changed in the preparation of the mixture. The ratio of the water/enhancer to the amount of petrol may be changed by special pumps and valves. The voltage may be changed by a voltage divider. As these considerations are made, it must be understood that the greater the electrolysis, the greater the demand on the electrical power system. The relative effects of each of the above factors, individually and collectively may be employed to achieve optimum results with such optimum results being identified by the most efficient use of petrol.

In a further test employing the same motor vehicle and fuel generator, the above described ICE was provided with a source of only one-half gallon of petrol and an unlimited amount of water/catalyst mixture. The petrol was fully consumed at 21 miles of travel (42 miles per gallon). When this petrol was exhausted, by increasing the voltage on the electrodes and increasing the fuel pressure, enough fuel was generated (without petrol) to power the vehicle adequately an additional three miles to its “home”, even though the power was very low.

In a given system of the present invention and the operation of such apparatus employing the method of the present invention, consideration is to be given to the sizing of the length and relative diameters of the elements of the apparatus, according to the desired amount of modified fuel required for a given ICE. Also, the amount of electrolysis depends upon the dimension of the elements, the adjustment of the elements with respect to each other, the amount of electricity applied to the electrodes and the regulated pressure from the fuel pump, all as will be recognized by one skilled in the art. As noted hereinabove, with a specific combination of petrol and water (with enhancer) along with an identified fuel pressure, a motor vehicle having a fuel generator of the present invention installed therein can about double the miles per gallon petrol consumed by the ICE in question.

The fuel generator has, also, been employed to use fuel directly from a retail pump with 90% gasoline and 10% ethanol (enhancer) without the addition of water. In this case, the original gasoline-ethanol mixture was taken directly from the fuel tank for the ICE and moved directly through the fuel generator to the ICE. Several specific tests have given mileage improvement of 33% to 50%.

Multiple tests of the fuel generator, over an extended period, were conducted with a 1994 Mercury Marquis with a 4.6 liter engine that normally gets 20 miles per gallon. All tests were conducted with gasoline with “not more than 10% ethanol” directly from the retailer pump. Variation in these results were expected due to not knowing the exact amount of ethanol.

The results of these tests are given in the following Tables A and B:

TABLE A
Tests with water added to gasoline:

| | |
|---|---|
| (1) | A test of 51 miles that used 1.6 gallons of gasoline for 32 miles per |
| | gallon. |
| (2) | A test of 101 miles that used 1.66 gallons of gasoline for 61 miles per |
| | gallon. |
| (3) | A test of 163 miles that used 5.02 gallons of gasoline for 32.5 miles |
| | per gallon. |
| (4) | A test of 48.3 miles that used 1.157 gallons of gasoline for 41.7 miles |
| | per gallon. |

TABLE B
Tests with “not less than 10% ethanol” gasoline with no water added:

| | |
|---|---|
| (1) | A test of 150 miles in which the automobile got 28 miles per gallon. |
| (2) | A test of 180 miles in which the automobile got 30 miles per gallon. |
| (3) | A test of 73 miles that used 2.7 gallons of gasoline for 27 miles per |
| | gallon. |
| (4) | A test of 410 miles that used 14.3 gallons of gasoline for 29 miles per |
| | gallons. |
| (5) | A test of 168 miles that used 5.8 gallons of gasoline for 29 miles per |
| | gallon. |
| (6) | A test of 450 miles that used 17.1 gallons of gasoline for 26.3 miles |
| | per gallon. |
| (7) | A test of 271 miles that used 10.3 gallons of gasoline for 26.3 miles |
| | per gallon. |
| (8) | A test of 206 miles that used 7.45 gallons of gasoline for 27.7 miles |
| | per gallon. |
| (9) | A test of 165 miles that used 5.85 gallons of gasoline for 28.2 miles |
| | per gallon. |

What is claimed is:

1. A method for enhancement of the efficiency of combustion of a fuel for an internal combustion engine comprising the steps of:
a) interposing an electrolysis fuel generator between a source of fuel and the location of fuel infeed to the internal combustion engine.
b) Feeding a fuel comprising gasoline and a hydrogen-containing enhancing fluid from said source to and through said fuel generator, whereby said fuel passing through said fuel generator is subjected to electrolysis.
c) Feeding said fuel exiting said fuel generator to said fuel infeed to the internal combustion engine.

2. The method of claim 1 and including the steps of introducing an electrolysis enhancer fluid to said fuel being fed to said fuel generator, and mixing said fuel and said enhancer fluid prior to feeding the same through said fuel generator.

3. The method of claim 1 wherein said fuel comprises gasoline containing ethanol.

4. The method of claim 3 wherein said ethanol is present within said fuel in an amount approximating 10% by volume of ethanol.

5. The method of claim 1 and including the step of: providing a regulated source of electrical power to said fuel generator, said electrical power being of a value less than that power which adversely affects the proper operation of said source of electrical power.

6. The method of claim 1 and including the step of optimizing the enhancement of said fuel passing through said fuel generator by regulating the duration of the residence time of said fuel fed into said fuel generator, said residence time being established by selective alternation of the physical size of at least one portion of the electrolysis field within the fuel generator.

7. The method of claim 1 wherein said fuel passing through said fuel generator is directed along a tortuous path.

8. The method of claim 2 wherein said enhancer fluid comprises water.

9. The method of claim 8 wherein said water is present in said fuel in an amount of less than about 50% by volume of said mixture of fuel and water.

10. The method of claim 1 wherein said fuel generator defines a pattern of elongated reverse flow paths of said fuel passing through said fuel generator.

11. Apparatus for enhancing the efficiency of combustion of a fluid fuel for an internal combustion engine comprising:
a) a source of fluid fuel comprising gasoline containing a hydrogen-containing enhancing fluid,
b) a fuel infeed to the internal combustion engine,
c) a fuel generator interposed in fluid communication between said source of fluid fuel and said fuel infeed,
d) said fuel generator having an infeed end and an outlet end comprising a plurality of flow paths for flow of said fluid fuel through said fuel generator,
e) at least one electrolysis field defined within said fuel generator and along said flow paths,
f) whereby the hydrogen content of said fluid fuel is increased as said fluid fuel passes through said fuel generator.

12. The apparatus of claim 11 wherein said fuel generator comprises a plurality of tubular electrically conductive housings having opposite first and second ends and being disposed in concentric spaced apart array to define open annular flow paths between respective ones of said housings, said housings having selected respective ones of their ends closed whereby fluid flow through said fuel generator may be directed along reversing elongated annular paths for fluid flow along said flow paths, and including at least one electrolysis field defined between adjacent ones of said housings.

13. The apparatus of claim 12 wherein said plurality of housings comprises at least a first outermost elongated cylindrical housing, an intermediate second elongated cylindrical housing disposed within and being electrically isolated from said at least first cylindrical housing, said second housing being of a lesser outer diameter than the inner diameter of said first housing, thereby defining an annular space therebetween, and a third innermost elongated cylindrical housing disposed within and being electrically isolated from said second housing, said third housing being of a lesser outer diameter than the inner diameter of said second intermediate housing, thereby defining an annular space therebetween, said first and third housings being of opposite electrical polarity.

14. The apparatus of claim 13 and including an infeed portion in fluid communication between said source of fuel and said first end of said third housing, said opposite end of said third housing being open for the flow of fluid fuel therefrom.

15. The apparatus of claim 14 wherein a first end of each of said first and second housings is disposed proximate, but spaced apart from, said infeed portion of said third housing and are closed, and said second end of each of said first and second housings terminating beyond said second end of said third housing and being closed, thereby interconnecting said annular spaces between said third and second and said second and first housings and defining a continuous circuitous flow path for fluid fuel within said fuel generator.

16. The apparatus of claim 15 including a source of electrical power and wherein said innermost housing is electrically connected to a first pole of said power source, and said intermediate second housing is electrically connected to a second and electrically opposite pole of said power source thereby providing for the development of an electrolysis field between said innermost housing and said second housing and between said outermost first housing and said intermediate second housing.
